(19) United States
(12) Patent Application Publication
(10) Pub. No.: US 2026/0186904 A1
(43) Pub. Date: Jul. 2, 2026

(54) LOAD-BALANCED COLLABORATIVE REPAIR METHOD AND DEVICE FOR CODED DATA

(71) Applicant: Northwestern Polytechnical University, Xi’an (CN)

(72) Inventors: Zhijie Huang, Xi’an (CN); Yulong Shi, Xi’an (CN); Shujie Han, Xi’an (CN); Nannan Zhao, Xi’an (CN); Xiao Zhang, Xi’an (CN); Xiaonan Zhao, Xi’an (CN)

(21) Appl. No.: 19/437,296

(22) Filed: Dec. 31, 2025

(30) Foreign Application Priority Data
Jan. 2, 2025 (CN) 202510001968.4

(51) Int. Cl. G06F 11/10; G06F 9/50

(52) U.S. Cl. CPC G06F 11/1084; G06F 9/505; G06F 11/1088

(57) ABSTRACT

The present application discloses a load-balanced collaborative repair method and device for coded data, and relates to the technical field of data storage and recovery. The method include performing encoded collaborative repair on data of a damaged disk using a collaborative repair algorithm BROR according to characteristics of the damaged disk and data characteristics of intact disks; and calculating locations of data required to be transmitted by each disk using a load balancing algorithm BROR-LB based on encoded collaborative repair results, implementing data balance among nodes, and completing load-balanced collaborative repair of coded data. The present application solves problems of low data recovery efficiency and unbalanced system load in large-scale storage systems.

### CROSS-REFERENCE TO RELATED APPLICATIONS

This application claims priority to Chinese Patent Application No. 202510001968.4, filed on Jan. 2, 2025, which is hereby incorporated by reference in its entirety.

### Technical Field

The present application relates to the technical field of data storage and recovery, and in particular, to a load-balanced collaborative repair method and device for coded data.

### BACKGROUND

### Description of Related Art

In modern data storage systems, particularly in large-scale cloud data centers and distributed storage systems, secure and efficient data recovery constitutes a core requirement. Erasure coding, as a widely applied technology, can effectively improve fault tolerance of storage systems and ensure data integrity and accessibility when facing hard disk failures. However, with the continuous growth of data volume and expansion of storage system scale, existing erasure coding technologies face a series of challenges, particularly in data recovery efficiency and system load balancing.

Conventional erasure coding technologies usually require reading a large amount of data from a plurality of intact disks to reconstruct lost data when a single disk fails. Such a method performs acceptably in small-scale systems. However, in large-scale data centers, this data recovery strategy causes substantial I/O load and network bandwidth consumption, thereby seriously affecting overall system performance and response time. Technologies such as RDOR emerging in recent years adopt collaborative repair algorithms, and achieve reduction of data transmission volume by repeatedly reusing redundant data among disks. However, such methods have a limitation of a limited number of parity disks, and when more than two parity disks are in a disk array, the methods such as RDOR become ineffective; in addition, load during a data recovery process is usually unevenly distributed among different nodes, causing certain nodes to face excessively high load while other nodes remain relatively idle; consequently, this imbalance further exacerbates system performance bottlenecks.

Although existing technologies attempt to improve recovery efficiency by optimizing design and implementation of erasure coding, these existing technologies still fail to satisfy requirements for rapid and balanced data recovery in large-scale environments

### SUMMARY

Aiming at the foregoing defects in the prior art, a load-balanced collaborative repair method and device for coded data provided by the present application solves problems of low data recovery efficiency and unbalanced system load in large-scale storage systems.

To achieve the above objective, the present application adopts the following technical solution. A load-balanced collaborative repair method for coded data includes the following steps:
S1: performing encoded collaborative repair on data of a damaged disk using a collaborative repair algorithm BROR according to characteristics of the damaged disk and data characteristics of intact disks; and
S2: calculating locations of data required to be transmitted by each disk using a load balancing algorithm BROR-LB based on encoded collaborative repair results, implementing data balance among nodes, and completing load-balanced collaborative repair of coded data.

Further, for a disk array using a BR code (C(p, n, r)), where p is an encoding parameter of the BR code and is a prime number, n represents a total number of disks, and r represents a number of parity disks, when data on any disk is damaged, p−1 data blocks to be repaired on a failed disk are divided into r groups, and all r parity rules are assigned to the r groups in a one-to-one mapping manner, and each group decodes and repairs damaged data according to an assigned parity rule. The grouping methods include a contiguous grouping method and a load-balanced grouping method, where the contiguous grouping method refers to evenly dividing a region to be divided into r contiguous groups according to an address order, and when equal division is not achievable, remaining regions are divided into a last group. Operations of the load-balanced grouping method are as follows: for a finite field GF(p), when a is a primitive element of the finite field GF(p), all non-zero elements of the finite field GF(p) are representable as powers of a modulo p, namely a0, a1, a2, . . . , ap−2 (mod p); initial states of r groups are all empty sets, and each group sequentially takes one element from the above sequence in a round-robin manner until all elements are taken; and a value of each element in each group is subtracted by 1, thereby obtaining a sequence number of a data block corresponding to the group. For p−1 lost data blocks, the collaborative repair algorithm BROR recovers

$$⌈ \frac{p - 1}{r} ⌉$$

data blocks by using a parity rule with a slope of i, thereby allowing parity data blocks generated by the r parity rules to all participate in data recovery, expressed by the formula:

$$⌈ \frac{p - 1}{r} ⌉ * r = p - 1 ,$$

where p represents an encoding parameter in erasure coding and is a prime number, n represents a number of disks or nodes participating in storage, and r represents a number of parity disks or nodes in a storage array.

Further, performing the encoded collaborative repair on the data of the damaged disk using the collaborative repair algorithm BROR includes the following substeps:
S11: assuming that a current disk array includes seven disks: disk 0, disk 1, disk 2, disk 3, disk 4, disk 5, and disk 6, where the disk 0, the disk 1, the disk 2, the disk 3, and the disk 4 are configured to store blocks, and the disk 5 and the disk 6 are configured to store parity data blocks;
S12: encoding information data using a BR code C(p=7, n=7, r=2) with set parameters, thereby obtaining two parity data blocks and storing the two parity data blocks on the disk 5 and the disk 6; and
S13: assuming information data on the disk 0 is damaged, based on the collaborative repair algorithm BROR, recovering a first three blocks using a parity rule with a slope of 0, and recovering a subsequent three blocks using a parity rule with a slope of 1, that is, data {d_{0,1}, d_{0,2}, d_{0,3}, d_{0,4}, d_{0,5}, d_{0,6}} is XORed to recover d_{0,0} on the disk 0, data {d_{1,1}, d_{1,2}, d_{1,3}, d_{1,4}, d_{1,5}, d_{1,6}} is XORed to recover d_{1,0} on the disk 0, data {d_{2,1}, d_{2,2}, d_{2,3}, d_{2,4}, d_{2,5}, d_{2,6}} is XORed to recover d_{2,0} on the disk 0, data {d_{2,1}, d_{1,2}, d_{0,3}, d_{5,5}, d_{4,5}} is XORed to recover d_{3,0} on the disk 0, data {d_{3,1}, d_{2,2}, d_{1,3}, d_{0,4}, d_{5,6}} is XORed to recover d_{4,0} on the disk 0, and data {d_{4,1}, d_{3,2}, d_{2,3}, d_{1,4}, d_{0,5}} is XORed to recover d_{5,0} on the disk 0;

Further, the load balancing algorithm BROR-LB includes the following substeps:
S21: for a finite field GF(p), where a is a primitive element of the finite field GF(p); assuming p=7, representing the finite field GF(7) as {x|0≤x≤6}, where the primitive element is set as 3;
S22: representing all non-zero elements of GF(p) as powers of a modulo p, namely a0, a1, a2, . . . , ap−2 (mod p); representing all non-zero elements in GF(7) as {3⁰, 3¹, 3², 3³, 3⁴, 3⁵} mod 7 using the primitive element based on the load balancing algorithm BROR-LB;
S23: initializing r groups as empty sets, sequentially taking one element from the above sequence for each group in a round-robin manner until all elements are taken, and subtracting 1 from each element in each group to obtain a sequence number of a data block corresponding to the group; arranging all non-zero elements in GF(7) according to S22 to obtain a sequence {1,3,2,6,4,5};
S24: setting a step size r as 3, partitioning the sequence {1,3,2,6,4,5} according to the step size to obtain sets D₁: {1,6}, D₂: {3,4}, and D₃: {2,5},
S25: assigning all r parity rules to r groups in a one-to-one mapping, determining a parity rule for each group, calculating locations of data blocks to be read from each disk according to BR code encoding rules, reading all data blocks required for repairing a failed disk into memory buffers, and for each data block to be repaired, determining other data blocks in the same parity set according to the assigned parity rule and performing XOR operations to calculate the data block to be repaired; for example, assuming a failed disk 0, performing data recovery on d_{i,0}(i∈D₁) using a parity rule with a slope of 0, performing data recovery on d_{i,0}(i∈D₂) using a parity rule with a slope of 1, and performing data recovery on d_{i,0}(i∈D₃) using a parity rule with a slope of 2 (this manner is equivalent to performing data recovery on d_{i,0}(i∈D₂) using a row parity rule, performing data recovery on d_{i,0}(i∈D₁) using a parity rule with a slope of 1, and performing data recovery on d_{i,0}(i∈D₃) using a parity rule with a slope of 2); and finally, writing the recovered data blocks from memory into corresponding locations on the disks.

The present application further adopts the following technical solution. A load-balanced collaborative repair method for coded data includes:
a single-disk failure repair module, configured to, upon occurrence of data loss, determine whether a number of damaged disks is 1, and initiate a collaborative repair algorithm BROR of the single-disk failure repair module when the number of damaged disks is 1 to perform collaborative repair of the lost data; and
a load balancing module, configured to calculate locations of data to be transmitted by each disk based on a load balancing algorithm BROR-LB, thereby achieving data balance among nodes.

The present application has the beneficial effects as follows: the method and device significantly improve data recovery efficiency and system stability through advanced coding techniques and load balancing strategies, particularly suitable for storage environments with large data volumes and high availability requirements. The implementation of these technologies not only reduces risks caused by data damage, but also optimizes resource utilization, thereby enhancing system economic efficiency and technical advantages.

### BRIEF DESCRIPTION OF THE DRAWINGS

FIG. 1 is a flowchart of a load-balanced collaborative repair method for coded data.

FIG. 2 is a schematic diagram illustrating a BR code encoding and storage principle provided by an exemplary embodiment of the present application.

FIG. 3 is a schematic diagram illustrating a conventional single-disk repair strategy of the BR code provided by an exemplary embodiment of the present application.

FIG. 4 is a schematic diagram illustrating a single-disk collaborative repair principle provided by an exemplary embodiment of the present application.

FIG. 5 is a schematic diagram illustrating unbalanced collaborative repair load when r=2 provided by an exemplary embodiment of the present application.

FIG. 6 is a schematic diagram illustrating unbalanced collaborative repair load when r=2 provided by an exemplary embodiment of the present application.

FIG. 7 is an effect diagram illustrating collaborative repair without using a load balancing algorithm provided by an exemplary embodiment of the present application.

FIG. 8 is a schematic diagram illustrating data transmission volume of a collaborative repair algorithm in a single-disk repair scenario provided by an exemplary embodiment of the present application.

FIG. 9 is a schematic diagram illustrating a disk data load balancing principle provided by an exemplary embodiment of the present application.

FIG. 10 is a schematic diagram illustrating load-balanced collaborative repair when r=3 provided by an exemplary embodiment of the present application.

FIG. 11 is a schematic diagram illustrating an optimized load balancing principle provided by an exemplary embodiment of the present application.

FIG. 12 is a schematic diagram illustrating repair speed of a collaborative repair algorithm in a single-disk failure scenario provided by an exemplary embodiment of the present application.

### DESCRIPTION OF EMBODIMENTS

The present application is further described below with reference to the accompanying drawings and specific embodiments.

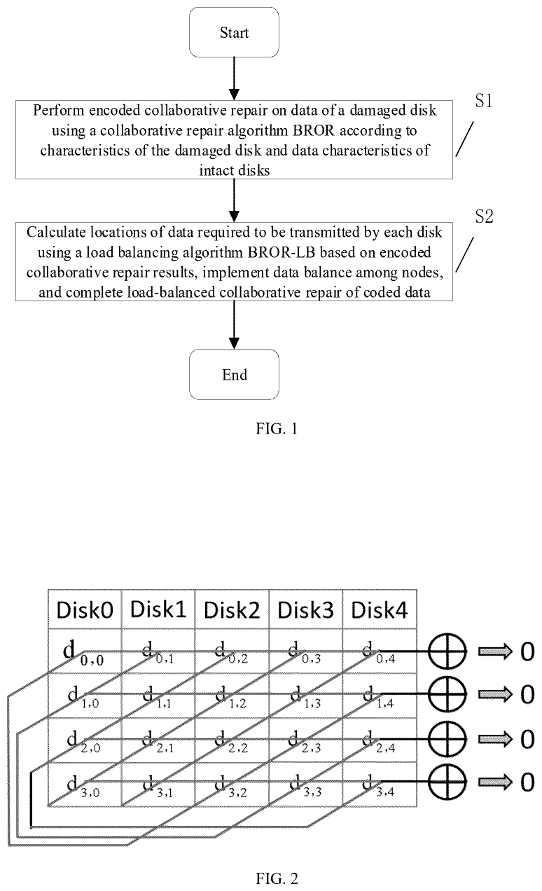

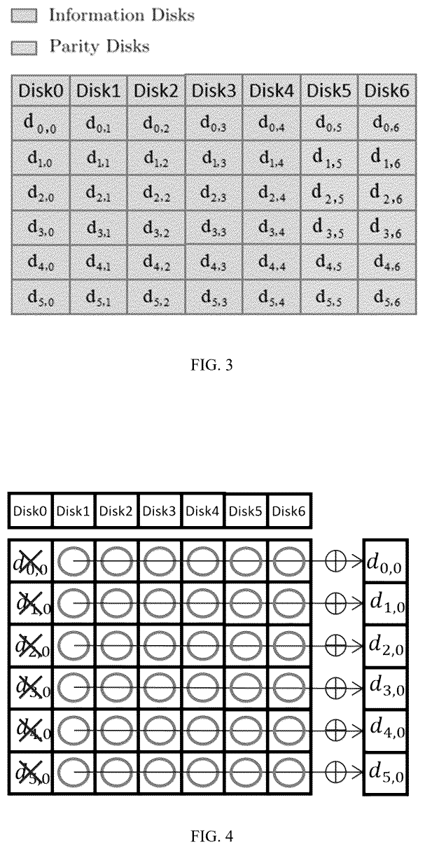

Embodiment 1: as shown in FIG. 1, a load-balanced collaborative repair method for coded data includes the following steps:

S1: performing encoded collaborative repair on data of a damaged disk using a collaborative repair algorithm BROR according to characteristics of the damaged disk and data characteristics of intact disks; and

S2: calculating locations of data required to be transmitted by each disk using a load balancing algorithm BROR-LB based on encoded collaborative repair results, implementing data balance among nodes, and completing load-balanced collaborative repair of coded data.

In this embodiment, the decoding and recovery process of a BR code is involved. The BR (Blaum-Roth) code is a binary maximum distance separable (MDS) array code based on a binary quotient ring F₂(x)/Mₚ(x), where Mₚ(x)=1+*+Λ+x^{p-1}, p is a prime number. The encoding process of the BR code achieves data redundancy and recovery capability by performing polynomial operations over the binary quotient rings. The construction of the BR code utilizes the ring Rₚ=F₂(x)/Mₚ(x) and when p is a prime number, the code can recover all information bits from any k polynomials out of n polynomials, thereby ensuring high reliability of the data.

A BR code array can be implemented through a plurality of data disks. The disks of the same size are arranged in an array to form a disk array storage system, as shown in FIG. 2. Among these disks, some are information disks, and the others are parity disks. The BR code performs operations on data of the information disks using parity rules with different slopes to obtain data of the parity disks, thereby protecting the information against disk failures. When a disk in the system fails, to maintain the reliability level of the system, data on the failed disk needs to be reconstructed by reading corresponding information and parity data from all surviving disks, and the recovered data should be stored on a spare disk as soon as possible.

In a conventional BR code recovery solution, when an information disk fails, each erased symbol can be recovered by reading parity bits of the corresponding row and other information symbols in the same row. Specifically, when a certain information disk fails, all symbols on the failed disk can be sequentially recovered by performing XOR operations using parity bits of the corresponding row and other information symbols in the row. This recovery process only uses a single parity column, resulting in low recovery efficiency, particularly for large-scale data recovery, where the number of reads and amount of calculation are both substantial.

The conventional single-disk failure recovery strategy recovers data using only a single parity column. However, all data blocks are protected by a plurality of different parity sets. The present application introduces a BROR algorithm that uses data from a plurality of parity disks for information recovery. The BROR algorithm utilizes information from all parity data, thereby achieving: (1) reducing the amount of data involved in disk read operations; and (2) ensuring load balancing of data transmission among all disks.

In the present application, for a disk array using a BR code (C(p, n, r)), where p is an encoding parameter of the BR code and is a prime number, n represents a total number of disks, and r represents a number of parity disks, when data on any disk is damaged, p−1 data blocks to be repaired on a failed disk are divided into r groups, and all r parity rules are assigned to the r groups in a one-to-one mapping manner, and each group decodes and repairs damaged data according to an assigned parity rule. The grouping methods include a contiguous grouping method and a load-balanced grouping method, where the contiguous grouping method refers to evenly dividing a region to be divided into r contiguous groups according to an address order, and when equal division is not achievable, remaining regions are divided into a last group. Operations of the load-balanced grouping method are as follows: for a finite field GF(p), when a is a primitive element of the finite field GF(p), all non-zero elements of the finite field GF(p) are representable as powers of a modulo p, namely a0, a1, a2, . . . , ap−2 (mod p); initial states of r groups are all empty sets, and each group sequentially takes one element from the above sequence in a round-robin manner until all elements are taken; and a value of each element in each group is subtracted by 1, thereby obtaining a sequence number of a data block corresponding to the group.

For p−1 lost data blocks, the collaborative repair algorithm BROR recovers

$$⌈ \frac{p - 1}{r} ⌉$$

data blocks by using a parity rule with a slope of i, thereby allowing parity data blocks generated by the r parity rules to all participate in data recovery, expressed by the formula:

$$⌈ \frac{p - 1}{r} ⌉ * r = p - 1 ,$$

where p represents an encoding parameter in erasure coding and is a prime number, n represents a number of disks or nodes participating in storage, and r represents a number of parity disks or nodes in a storage array.

Performing the encoded collaborative repair on the data of the damaged disk using the collaborative repair algorithm BROR includes the following substeps:
S11: assuming that a current disk array includes seven disks: disk 0, disk 1, disk 2, disk 3, disk 4, disk 5, and disk 6, where the disk 0, the disk 1, the disk 2, the disk 3, and the disk 4 are configured to store blocks, and the disk 5 and the disk 6 are configured to store parity data blocks;
S12: encoding information data using a BR code C(p=7, n=7, r=2) with set parameters, thereby obtaining two parity data blocks and storing the two parity data blocks on the disk 5 and the disk 6; and
S13: assuming information data on the disk 0 is damaged, based on the collaborative repair algorithm BROR, recovering a first three blocks using a parity rule with a slope of 0, and recovering a subsequent three blocks using a parity rule with a slope of 1, that is, data {d_{0,1}, d_{0,2}, d_{0,3}, d_{0,4}, d_{0,5}, d_{0,6}} is XORed to recover d_{0,0} on the disk 0, data {d_{1,1}, d_{1,2}, d_{1,3}, d_{1,4}, d_{1,5}, d_{1,6}} is XORed to recover d_{1,0} on the disk 0, data {d_{2,1}, d_{2,2}, d_{2,3}, d_{2,4}, d_{2,5}, d_{2,6}} is XORed to recover d_{2,0} on the disk 0, data {d_{2,1}, d_{1,2}, d_{0,3}, d_{5,5}, d_{4,5}} is XORed to recover d_{3,0} on the disk 0, data {d_{3,1}, d_{2,2}, d_{1,3}, d_{0,4}, d_{5,6}} is XORed to recover d_{4,0} on the disk 0, and data {d_{4,1}, d_{3,2}, d_{2,3}, d_{1,4}, d_{0,5}} is XORed to recover d_{5,0} on the disk 0;

In this embodiment, it is assumed that information data on the disk 0 is damaged, and therefore six data blocks. d_{i,0}(0≤i≤5) on the disk 0 need to be recovered using data from other disks. When a conventional data recovery strategy is used, data from the disk 1, the disk 2, the disk 3, the disk 4, the disk 5, and the disk 6 are used to perform XOR operations, thereby recovering the disk 0 using a parity rule with a slope of 0. Therefore, a total of 6×6=36 data blocks are required. As shown in FIG. 4, in this embodiment, X is used to represent the lost data blocks, and O is used to represent the data blocks used for recovery.

For a single-disk failure, data can be recovered using any single parity set; therefore, the conventional recovery strategy represents only one of many possible solutions. In the example of FIG. 4, the conventional solution can recover data using a parity set with a slope of 0, or using a parity set with a slope of 1.

For the collaborative repair strategy RDOR of RDP codes, it is indicated that if d_{i,0}(0≤i≤2) is recovered using a parity set with a slope of 0, and d_{i,0}(3≤i≤5) is recovered using a parity set with a slope of 1, then ultimately d_{i,0}(0≤i≤5) on the disk 0 is recovered using information from 24 data blocks.

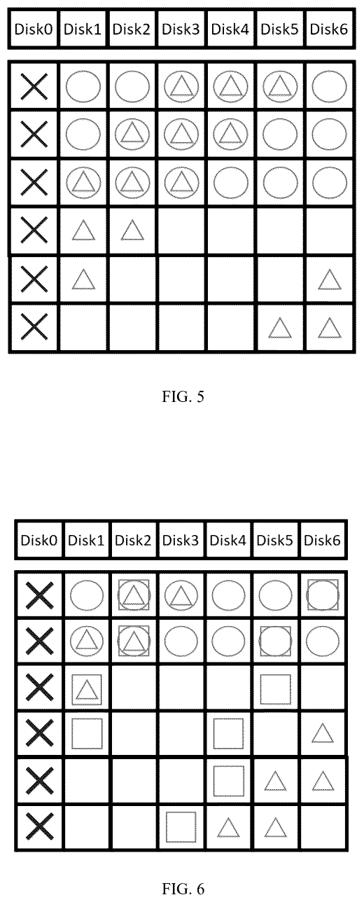

The specific implementation is illustrated in FIG. 5. Compared with the conventional recovery method, which requires 16 data blocks for recovery, BROR achieves a significant improvement in the amount of data accessed. Moreover, unlike RDOR, which has an inherent limit on the number of parity disks, BROR can be applied to disk arrays with any number of parity disks, providing a collaborative repair strategy (as shown in FIG. 6 for the scenario of r=3 under RDOR). This feature is particularly significant in distributed scenarios. In BROR, data blocks used for recovery are redundant, allowing network I/O or disk I/O required by conventional recovery methods to be converted into faster memory data access, thereby improving data recovery speed. Even in single-machine environments where the I/O speed difference is small, the reduction in data transmission achieved by BROR remains substantially meaningful.

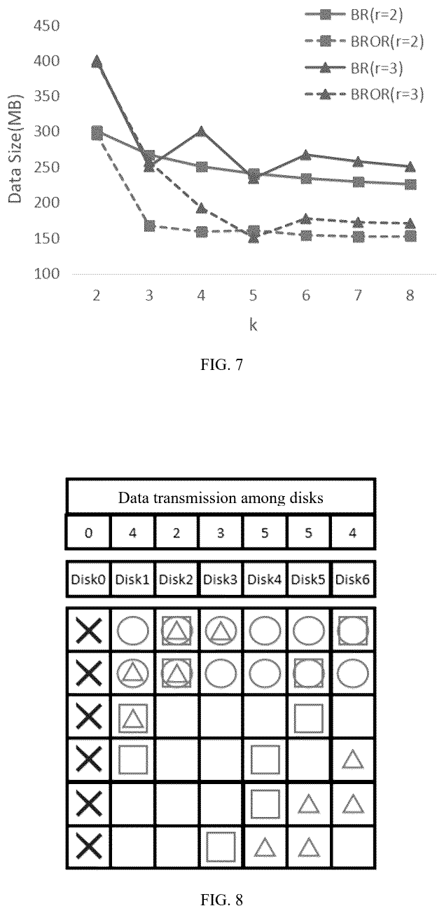

FIG. 7 illustrates the amount of data to be transmitted for data recovery in a single-disk failure scenario with a total data volume of 200 MB, using a conventional decoding algorithm and the BROR algorithm, respectively. As shown in FIG. 7, compared with the conventional decoding algorithm, BROR can reduce the amount of data required for recovery in a single-disk failure scenario by approximately 80-100 MB, corresponding to 22% to 27%, and can maintain a similar optimization effect when r>2.

In this embodiment, the erased data in the first two rows of the matrix is recovered using a parity rule with a slope of 0, and the erased data in the last two rows of the matrix is recovered using a parity rule with a slope of 1. This approach is the most straightforward and also achieves the principle of minimizing the data involved in recovery. However, the amount of data used for recovery in each disk is not uniform. This issue is particularly significant in distributed environments, where the node with lost data needs to request data from all nodes storing complete data via network I/O and then perform data recovery locally. When the amounts of data involved in recovery across different nodes vary greatly, the data recovery efficiency often depends on the node with the largest data transfer, which can affect the performance of the BROR algorithm to some extent.

As shown in FIG. 8, data is stored using a BR code C(p=7, n=7, r=3), with the disk 4, the disk 5, and the disk 6 serving as parity data disks. In a distributed environment, assuming data on the disk 0 is lost, d_{i,0}(0≤i≤1) is recovered using a parity rule with a slope of 0, d_{i,0}(2≤i≤3) is recovered using a parity rule with a slope of 1, and d_{i,0} (4≤i≤5) is recovered using a parity rule with a slope of 2; the disk 4 and the disk 5 need to transmit five data blocks, the disk 1 and the disk 6 need to transmit four data blocks, and the disk 3 and the disk 2 need to transmit three and two data blocks, respectively. The uneven data load across nodes ultimately affects the data recovery speed.

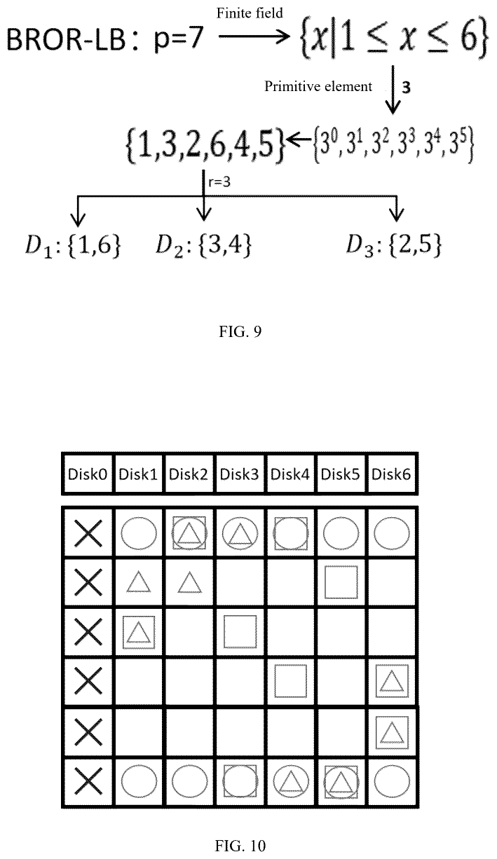

Based on this phenomenon, the present application proposes a load balancing algorithm for data transmission among nodes, BROR-LB, as shown in FIG. 9. This algorithm can maximize the uniform distribution of data involved in recovery across nodes or disks, thereby optimizing the performance of the BROR algorithm.

In one embodiment of the present application, under the premise of p=7, load balancing for data recovery is effectively equivalent to grouping d_{i,0} (0≤i≤5) The BROR algorithm can maximize recovery efficiency only when the erased data is repaired by different parity rules with equal amounts of data. Therefore, when p=7 and r=3, d_{i,0} (0≤i≤5) needs to be divided into three equally sized sets D₁, D₂, and D₃. The objective of BROR-LB is to evenly partition the integer sets while ensuring data recoverability.

The load balancing algorithm BROR-LB includes the following substeps:
S21: for a finite field GF(p), where a is a primitive element of the finite field GF(p); assuming p=7, representing the finite field GF(7) as {x|0≤x≤₆}, where the primitive element is set as 3;
S22: representing all non-zero elements of GF(p) as powers of a modulo p, namely a0, a1, a2, . . . , ap−2 (mod p); representing all non-zero elements in GF(7) as {3⁰, 3¹, 3², 3³, 3⁴, 3⁵} mod 7 using the primitive element based on the load balancing algorithm BROR-LB;
S23: initializing r groups as empty sets, sequentially taking one element from the above sequence for each group in a round-robin manner until all elements are taken, and subtracting 1 from each element in each group to obtain a sequence number of a data block corresponding to the group; arranging all non-zero elements in GF(7) according to S22 to obtain a sequence {1,3,2,6,4,5};
S24: assuming that the number of parity disks r is 3, partitioning the sequence {1,3,2,6,4,5} with a step size of 3 to obtain sets D₁: {1,6} D₂: {3,4}, and D₃: {2,5};
S25: assigning all r parity rules to r groups in a one-to-one mapping, determining a parity rule for each group, calculating locations of data blocks to be read from each disk according to BR code encoding rules, reading all data blocks required for repairing a failed disk into memory buffers, and for each data block to be repaired, determining other data blocks in the same parity set according to the assigned parity rule and performing XOR operations to calculate the data block to be repaired; for example, representing an index of a failed disk as j, performing data recovery on d_{i,j}(i∈D₁) using a parity rule with a slope of 0, performing data recovery on d_{i,j}(i∈D₂) using a parity rule with a slope of 1, and performing data recovery on d_{i,j}(i∈D₃) using a parity rule with a slope of 2; and finally, writing the recovered data blocks from memory into corresponding locations on the disks.

The BROR after performing set partitioning using BROR-LB is capable of ensuring load balancing of recovery data to the greatest extent possible. As shown in FIG. 10, the disk 0 to the disk 6 each are required to transmit three to four data blocks to perform data recovery.

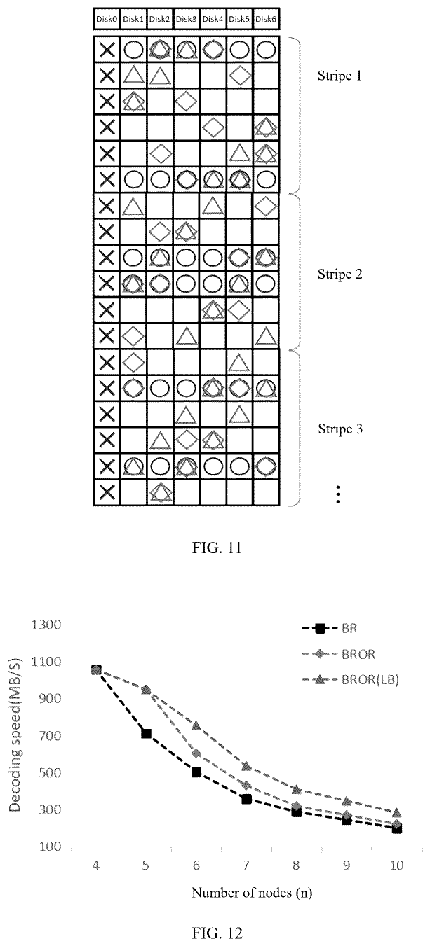

The BROR-LB algorithm used is capable of achieving a fully load-balanced state of data in some cases; however, in more cases, a situation occurs in which data cannot be completely evenly distributed as in the foregoing embodiment, that is, 22 parity data blocks required for recovery cannot be evenly distributed among six nodes. A reason is that performing the BROR-LB algorithm produces three sets D₁: {1,6} D₂: {3,4}, and D₃: {2,5}, such that the disk 3 and the disk 4 transmit three data blocks, and remaining disks transmit four data blocks. In view of this phenomenon, during data recovery, the present application adopts a manner of stripe-wise data rotation to optimize load balancing. As shown in FIG. 11, if stripe x performs recovery on d_{i,0}(i=0|i=5) using a parity rule with a slope of 0, such that the disk 3 and the disk 4 are required to transmit three data blocks, then stripe x+1 performs recovery on d_{i,0}(i=0∥i=5) using a parity rule with a slope of 1. As a result, from a macroscopic perspective, data required for recovery are distributed among disks as evenly as possible.

In this embodiment, the effects of a conventional decoding algorithm, a BROR algorithm, and a BROR algorithm including a load balancing strategy are respectively tested in a single-machine environment under the scenario. FIG. 12 illustrates a failure repair speed of BROR in a single-machine scenario, that is, a decoding rate of a BR code during single-disk repair. As shown in FIG. 12, the BROR algorithm improves a decoding rate by approximately 10% to 19% compared with the conventional repair algorithm, and an optimization effect decreases with an increase of k. The BROR-LB algorithm exhibits a more significant improvement compared with the BROR algorithm, and a decoding rate maintains an improvement of approximately 20%, because the load balancing strategy enables transmitted data volumes required by respective disks to be more uniform, thereby reducing a tail latency effect.

Embodiment 2: A load-balanced collaborative repair device for coded data includes a single-disk failure repair module and a load balancing module.

The single-disk failure repair module is configured to, upon occurrence of data loss, determine whether a number of damaged disks is 1, and initiate a collaborative repair algorithm BROR of the single-disk failure repair module when the number of damaged disks is 1 to perform collaborative repair of the lost data.

The single-disk failure repair module performs a calculation according to encoding parameter information to obtain data volumes required to be transmitted by each disk, and invokes the load balancing module to calculate locations of data to be transmitted by each disk based on whether load balancing is enabled, thereby ultimately implementing collaborative repair of coded data. That is, according to a position of a failed disk and related parameters of an employed code, locations of surviving data blocks required to be read during single-stripe collaborative repair are determined, and the data blocks are read into a cache.

The load balancing module is configured to calculate locations of data to be transmitted by each disk based on a load balancing algorithm BROR-LB, thereby achieving data balance among nodes.

That is, according to a position of a failed disk and related parameters of an employed code, locations of surviving data blocks required to be read for load-balanced multi-stripe collaborative repair are determined, and the data blocks are read into a cache.

The present application provides a load-balanced collaborative repair method for coded data and a corresponding device, which aims to solve problems of low data recovery efficiency and unbalanced system load in large-scale storage systems. By adopting an improved BR code and a collaborative repair strategy, the present application not only increases a speed of data recovery but also optimizes load distribution in data centers, and is particularly suitable for cloud storage environments requiring high data reliability and fast recovery capability.

The collaborative repair method of the present application includes encoding data stored in each disk array using the BR code, such that loss of data on any single disk can be recovered from data on other disks. During data recovery, data from a plurality of disks are all used to improve recovery efficiency. By collaboratively distributing the recovery tasks among a plurality of disks, the present application reduces effects of a single point of failure and alleviates load pressure on individual disks.

The present application introduces a dynamic load balancing strategy, which dynamically adjusts allocation of data recovery tasks according to current workloads of each storage node. This strategy not only ensures high efficiency of the data recovery process but also prevents overall system performance degradation caused by overload of certain nodes. By evenly distributing data recovery transmission volumes among nodes or disks, the present application significantly improves a load balancing characteristic of erasure coding during single-disk recovery.

To achieve these technical objectives, the present application further provides a set of corresponding devices, including but not limited to a single-disk failure repair module and a load balancing module. These modules work together to enable rapid data recovery and efficient operation of the entire system. The single-disk failure repair module is configured to process data encoded by the BR code, quickly locate and repair damaged data; this module performs calculation and recovery of lost data through the collaborative repair algorithm proposed by the present application, thereby improving recovery efficiency in single-disk failure scenarios by reducing a volume of data involved in the repair process. The load balancing module determines locations of surviving data blocks required to be read for data recovery under load balancing according to a position of a failed disk and related parameters of the employed code, which ensures that all recovered data are evenly distributed among different storage nodes and prevents any single node from becoming a bottleneck.

It will be appreciated by those of ordinary skill in the art that the embodiments described herein are intended to help readers understand the principles of the present application, and it should be understood that the protection scope of the present application is not limited to such specific descriptions and embodiments. Those of ordinary skill in the art may make various other specific modifications and combinations based on the technical inspirations disclosed in the present application without departing from the essence of the present application, and these modifications and combinations are still within the protection scope of the present application.

1. A load-balanced collaborative repair method for coded data, comprising the following steps:
S1: performing encoded collaborative repair on data of a damaged disk using a collaborative repair algorithm BROR according to characteristics of the damaged disk and data characteristics of intact disks; wherein
performing the encoded collaborative repair on the data of the damaged disk using the collaborative repair algorithm BROR comprises the following substeps:
S11: assuming that a current disk array comprises seven disks: disk 0, disk 1, disk 2, disk 3, disk 4, disk 5, and disk 6, wherein the disk 0, the disk 1, the disk 2, the disk 3, and the disk 4 are configured to store blocks, and the disk 5 and the disk 6 are configured to store parity data blocks;
S12: encoding information data using a BR code C(p=7, n=7, r=2) with set parameters, thereby obtaining two parity data blocks and storing the two parity data blocks on the disk 5 and the disk 6;
S13: assuming that information data on the disk 0 is damaged, based on the collaborative repair algorithm BROR, recovering a first three data blocks using a parity rule with a slope of 0, and recovering a subsequent three data blocks using a parity rule with a slope of 1, that is, data {d_{0,1}, d_{0,2}, d_{0,3}, d_{0,4}, d_{0,5}, d_{0,6}} is XORed to recover d_{0,0} on the disk 0, data {d_{1,1}, d_{1,2}, d_{1,3}, d_{1,4}, d_{1,5}, d_{1,6}} is XORed to recover d_{1,0} on the disk 0, data {d_{2,1}, d_{2,2}, d_{2,3}, d_{2,4}, d_{2,5}, d_{2,6}} is XORed to recover d_{2,0} on the disk 0, data {d_{2,1}, d_{1,2}, d_{0,3}, d_{5,5}, d_{4,5}} is XORed to recover d_{3,0} on the disk 0, data {d_{3,1}, d_{2,2}, d_{1,3}, d_{0,4}, d_{5,6}} is XORed to recover d_{4,0} on the disk 0, and data {d_{4,1}, d_{3,2}, d_{2,3}, d_{1,4}, d_{0,5}} is XORed to recover d_{5,0} on the disk 0;
S2: calculating locations of data required to be transmitted by each disk using a load balancing algorithm BROR-LB based on encoded collaborative repair results, implementing data balance among nodes, and completing load-balanced collaborative repair of coded data; wherein
the load balancing algorithm BROR-LB comprises the following substeps:
S21: assuming p=7, representing a corresponding finite field GF(7) as {x|0≤x≤6}, wherein a primitive element is set as 3;
S22: representing all non-zero elements in the finite field GF(7) as {3⁰, 3¹, 3², 3³, 3⁴, 3⁵} mod 7 using the primitive element based on the load balancing algorithm BROR-LB;
S23: arranging the all non-zero elements in the finite field GF(7) according to the S22 to obtain a sequence {1,3,2,64,5};
S24: assuming that a number of parity disks r is 3, partitioning the sequence {1,3,2,6,4,5} with a step size of 3 to obtain sets D₁: {1,6}, D₂: {3,4} D₃: {2,5}; and
S25: representing an index of a failed disk as i, performing data recovery on d_{i,j}(i∈D₁) d_{i,j}(i∈D₁) using a parity rule with a slope of 0, performing data recovery on d_{i,j}(i∈D₂) using a parity rule with a slope of 1, and performing data recovery on d_{i,j}(i∈D₃) using a parity rule with a slope of 2.

2. The load-balanced collaborative repair method for coded data according to claim 1, wherein for a disk array using a BR code (C(p,n,r)), when data on any disk is damaged, the collaborative repair algorithm BROR repairs the damaged data using all r parity rules; and for p−1 lost data blocks, the collaborative repair algorithm BROR recovers
$$⌈ \frac{p - 1}{r} ⌉$$
data blocks by using a parity rule with a slope of i, thereby allowing parity data blocks generated by the r parity rules to all participate in data recovery, expressed by the formula:
$$⌈ \frac{p - 1}{r} ⌉ * r = p - 1 ,$$
wherein p represents an encoding parameter in erasure coding and is a prime number, n represents a number of disks or nodes participating in storage, and r represents a number of parity disks or nodes in a storage array.

3-4. (canceled)

5. A device using the load-balanced collaborative repair method for coded data according to claim 1, comprising:
a single-disk failure repair module, configured to, upon occurrence of data loss, determine whether a number of damaged disks is 1, and initiate a collaborative repair algorithm BROR of the single-disk failure repair module when the number of damaged disks is 1 to perform collaborative repair of the lost data; and
a load balancing module, configured to calculate locations of data to be transmitted by each disk based on a load balancing algorithm BROR-LB, thereby achieving data balance among nodes.
